(19) United States
(12) Patent Application Publication
(10) Pub. No.: US 2012/0225973 A1
(43) Pub. Date: Sep. 6, 2012

(54) RUBBER COMPOSITION FOR PNEUMATIC TIRE TREAD FOR HEAVY LOAD, AND PNEUMATIC TIRE FOR HEAVY LOAD

(75) Inventor: Shinya Hasegawa, Osaka-shi (JP)

(73) Assignee: TOYO TIRE & RUBBER CO., LTD., Osaka (JP)

(21) Appl. No.: 13/365,836

(22) Filed: Feb. 3, 2012

(30) Foreign Application Priority Data
Mar. 4, 2011 (JP) 2011-047872

(51) Int. Cl. C08K 3/04

(52) U.S. Cl. 523/150

(57) ABSTRACT

A rubber composition for a pneumatic tire tread for heavy load, comprising a rubber component, and a carbon black, the carbon black satisfies (1) the carbon black has a dibutyl phthalate (DBP) absorption number of 90 to 180 mL/100 g, (2) the difference between the BET specific surface area (BET5) [unit: m²/g] of the carbon black and the external specific surface area (STSA) [unit: m²/g] thereof satisfies the following: 5<BET5−STSA<12, (3) the ratio between the Stokes diameter (Dst) of the carbon black and the Stokes diameter distribution (ΔD-50 (half band width)) thereof satisfies the following: 0.70<(ΔD-50)/Dst<1.10, and (4) the ratio between the BET specific surface area (BET5) [unit: m²/g] of the carbon black and the iodine adsorption number (IA) [unit: mg/g] thereof satisfies the following: 1.05<BET5/IA<1.35.

### BACKGROUND OF THE INVENTION

1. Field of the Invention

The present invention relates to a rubber composition, for a pneumatic tire tread for heavy load, that contains a rubber component and carbon black, and is adopted, in particular, in a pneumatic tire for heavy load, and that is improved in heat-generation-restraining property (i.e., low-exothermic-property) while kept about abrasion resistance, workability and tearing resistance; and a pneumatic tire for heavy load.

2. Description of Related Art

About pneumatic tires for heavy load that are used in, for example, trucks, buses and vehicles for construction, which may run under a heavy load condition, the tearing resistance, the abrasion resistance and the heat-generation-restraining property thereof are required to be improved. In order to improve these characteristics, carbon black has been hitherto used as a rubber reinforcing agent for a pneumatic tire, the carbon black being easily dispersed in rubber, and can give abrasion resistance and other physical properties to the rubber. For example, it is known that the abrasion resistance of rubber is improved by making the diameter of particles of the carbon black small, increasing the blend amount of the carbon black, structuring aggregates of the carbon black up to a high level, or making the activity of particle-surfaces of the carbon black high (i.e., increasing the number of functional groups which the surfaces have).

From the viewpoint of energy saving, the market intensely requires the rolling resistance of tires to be decreased in order to save the fuel consumption of automobiles. In order to decrease the rolling resistance of tires, it is effective to decrease the hysteresis loss of their tire tread regions, which give the highest effect onto the rolling resistance, and improve the heat-generation-restraining property of the regions (i.e., restrain the regions from generating heat). In order to produce a tire which is decreased in hysteresis loss and improved in heat-generation-restraining property, for example, the following measure is known: the blend amount of carbon black which is used as a rubber reinforcing agent is decreased; the particle diameter of the carbon black is made large; aggregates of the carbon black is structured down to a low level; or silica and/or a surfactant is/are used together therewith.

However, when attempts are made for improving various characteristics of tires by controlling the particle diameter, the structure and other properties of the carbon black, it is difficult that the heat-generation-restraining property of the tires is improved while the abrasion resistance thereof is kept since the abrasion resistance and the heat-generation-restraining property have an antinomy relationship therebetween. Additionally, following the adjustment of properties or the blend amount of the carbon black, and further the additional use of silica and/or some other, the tires may be deteriorated in tearing resistance, and workability. It is therefore very difficult to improve these tire characteristics with a good balance.

Patent Document 1 states that the following rubber composition can attain the compatibility of abrasion resistance with a decrease in rolling resistance: a rubber composition containing a carbon black (i.e., a carbon black species) and a working aid that is at least one of an aliphatic acid ester and an aliphatic acid metal salt, wherein the carbon black is a carbon black about which: the heating loss is adjusted to 0.87% or more by mass in the range of from 150 to 450° C.; the toluene coloring permeation ratio, to 90% or more; and the ratio between the nitrogen adsorption specific surface area (N₂SA) [unit: m²/g] and the iodine adsorption number (IA) [unit: mg/g], into the range of 1.10 to 1.30. Patent Document 2 states that the following rubber composition can attain the compatibility of abrasion resistance with heat-generation-restraining property: a rubber composition containing a carbon black about which the cetytriammonium specific surface area (CTAB) [unit: m²/g] is adjusted into the range of 115 to 145; the ratio between the DBP absorption number (24M4DBP) [unit: mL/100 g] and the area CTAB, into the range of 0.75 to 0.92; and the ratio between CTAB and IA, into the range of 0.97 to 1.25; and further the specific coloration quantity TINT [unit: %] and others satisfy an expression of “TINT>−46.787(24M4DBP/CTAB)+168”. Furthermore, Patent Document 3 states that the following rubber composition can attain the compatibility of abrasion resistance with heat-generation-restraining property: a rubber composition containing a carbon black about which the ratio of N₂SA to IA is adjusted into the range of 1.20 to 1.30, and the difference between N₂SA and CTAB is adjusted to 5 or less. Furthermore, Patent Document 4 states that the following rubber composition can attain the compatibility of abrasion resistance with heat-generation-restraining property: a rubber composition containing a carbon black about which the area CTAB is 120 or more, the compressive DBP absorption number is 90 mL/100 g, or more, and the quantity of the volume of pores each having a pore diameter of 25 to 30 nm, in the volume of pores between aggregates, is 30 mL/100 g or more.

However, the inventors have made eager investigations to find out that only by optimizing the individual indexes of a carbon black to which attention is paid in the above-mentioned literatures, it is difficult to understand precisely the degree of pores in the surfaces of aggregates of the carbon black. The degree of pores in the carbon black aggregate surfaces produces a larger effect, in particular, onto the abrasion resistance and the heat-generation-restraining property of the rubber composition concerned (i.e., a rubber composition containing the carbon black). Thus, it has been understood that the carbon blacks used in the literatures each have a room to be further improved in the case of attaining, in particular, the compatibility of the abrasion resistance of the composition with the heat-generation-restraining property.

Patent Document 5 describes a rubber composition containing a diene based rubber, and a carbon black, the amount of the carbon black being from 20 to 50 parts by mass for 100 parts by mass of the diene based rubber, the carbon black having a nitrogen adsorption specific surface area of 120 to 180 m²/g and a dibutyl phthalate absorption number of 130 mL/100 g or more, the loss tangent tan δ of the composition being 0.15 or less at a measuring temperature of 60° C., and the JIS hardness of the composition being from 50 to 70 degrees at a measuring temperature of 25° C. Patent Document 6 discloses a radial tire for a heavy vehicle having a tread region formed to include a rubber composition in which a polysulfide polymer having a polyether bond, and sulfur are incorporated into a rubber component composed of a polyisoprene-structured rubber and a polystyrene/butadiene rubber.

However, the inventors have found out that the rubber-component/carbon-black combination described in the literature has a room to be further improved, in particular, in heat-generation-restraining property.

Patent Document 1: JP-A-2009-40904

Patent Document 2: JP-A-2000-344945

Patent Document 3: JP-A-2007-231179

Patent Document 4: JP-A-2005-344063

Patent Document 5: JP-A-5-25326

Patent Document 6: JP-B-4-69183

### SUMMARY OF THE INVENTION

In light of the above-mentioned actual situation, the present invention has been made. An object thereof is to provide a rubber composition, for a pneumatic tire tread for heavy load, that is improved in heat-generation-restraining property while kept about abrasion resistance, workability and tearing resistance; and a pneumatic tire for heavy load having a tread region wherein this composition is used.

In order to solve the above-mentioned problems, the inventors have made eager investigations about methods for grasping the degree of pores in the surfaces of carbon black aggregates precisely. As a result, the inventors have found out that according to a carbon black about which the difference between the BET specific surface area (BET5) and the external specific surface area (STSA) is in a specified range, the degree of pores in the surfaces of aggregates of the carbon black is particularly preferred for a matter that a composition containing the carbon black attains the compatibility of abrasion resistance with heat-generation-restraining property. Furthermore, the inventors have found out that a tire can be improved in heat-generation-restraining property while kept about abrasion resistance, workability and tearing resistance by using, as the raw material thereof, a rubber composition containing a carbon black that is optimal for relationships among the dibutyl phthalate (DBP) absorption number, the iodine adsorption number (IA), the Stokes diameter (Dst) and the Stokes diameter distribution (ΔD-50 (half band width)) thereof, which have been hitherto used as indexes for representing properties of any carbon black, as well as BET5 and STSA. The present invention has been made on the basis of results of the investigations, and can attain the object. The present invention is as follows:

The present invention relates to a rubber composition for a pneumatic tire tread for heavy load, comprising a rubber component, and a carbon black, wherein the rubber component contains 30 to 90 parts by mass of a natural rubber or a polyisoprene rubber, 10 to 70 parts by mass of a polystyrene/butadiene rubber, and 0 to 60 parts by mass of a polybutadiene rubber in 100 parts by mass of the rubber component, and the carbon black satisfies the following (1) to (4):

(1) the carbon black has a dibutyl phthalate (DBP) absorption number of 90 to 180 mL/100 g,

(2) the difference between the BET specific surface area (BET5) [unit: m²/g] of the carbon black and the external specific surface area (STSA) [unit: m²/g] thereof satisfies the following: 5<BET5−STSA<12,

(3) the ratio between the Stokes diameter (Dst) of the carbon black and the Stokes diameter distribution (ΔD-50 (half band width)) thereof satisfies the following: 0.70<(ΔD-50)/Dst<1.10, and

(4) the ratio between the BET specific surface area (BET5) [unit: m²/g] of the carbon black and the iodine adsorption number (IA) [unit: mg/g] thereof satisfies the following: 1.05<BET5/IA<1.35.

The rubber composition for a pneumatic tire tread for heavy load according to the present invention can attain the compatibility of abrasion resistance with heat-generation-restraining property with a good balance since (1) the carbon black therein has a dibutyl phthalate (DBP) absorption number of 90 to 180 mL/100 g. The DBP absorption number is an index of the structuring of aggregates of the carbon black. If the DBP absorption number is less than the range described in the item (1), the level of the structuring of the carbon black aggregates is too low so that the composition tends to be deteriorated in abrasion resistance. On the other hand, if the DBP absorption number is more than this range, the level of the structuring of the carbon black aggregates is too high so that the composition tends to be deteriorated in heat-generation-restraining property.

Moreover, in the rubber composition according to the present invention, (2) the difference between the BET specific surface area (BET5) [unit: m²/g] of the carbon black and the external specific surface area (STSA) [unit: m²/g] thereof satisfies the following: 5<BET5−STSA<12. The BET specific surface area (BET5) and the external specific surface area (STSA) of a substance are each an index concerned with the specific surface area thereof that is calculated out on the basis of the nitrogen adsorption number thereof. Thus, by calculating the difference between the two indexes of the carbon black, the degree of pores in the surfaces of the carbon black aggregates can be precisely grasped.

Molecules of the rubber component cannot be inserted into the pores in the carbon black aggregate surfaces; thus, as the number of the pores is larger, the bonding between the carbon black and the rubber molecules is weaker. In the present invention, a relationship between the BET specific surface area BET5 and the external specific surface area STSA of the carbon black, i.e., “BET5−STSA” satisfies the item (2), so that the bonding between the carbon black and the rubber molecules is made very satisfactory. As a result, the composition can attain the compatibility of abrasion resistance with heat-generation-restraining property with a good balance.

Furthermore, in the rubber composition according to the present invention, (3) the ratio between the Stokes diameter (Dst) of the carbon black and the Stokes diameter distribution (ΔD-50 (half band width)) thereof satisfies the following: 0.70<(ΔD-50)/Dst<1.10. Thus, the rubber composition can be improved in abrasion resistance, heat-generation-restraining property, and tearing resistance with a good balance. If the ratio of (ΔD-50)/Dst is less than the range described in the item (3), the composition tends to be deteriorated in heat-generation-restraining property. On the other hand, if the ratio of (ΔD-50)/Dst is more than this range, the composition tends to be deteriorated in abrasion resistance and tearing resistance.

Additionally, in the rubber composition according to the present invention, (4) the ratio between the BET specific surface area (BET5) [unit: m²/g] of the carbon black and the iodine adsorption number (IA) [unit: mg/g] thereof satisfies the following: 1.05<BET5/IA<1.35. Thus, the bonding between the carbon black and the rubber molecules is optimized so that the composition can be improved in abrasion resistance and heat-generation-restraining property with a better balance. The ratio of BET5/IA is an index of the surface activity of particles of the carbon black. If the ratio of BET5/IA is less than the range described in the item (4), the composition tends to be deteriorated in heat-generation-restraining property. On the other hand, if the ratio of BET5/IA is more than this range, the composition tends to be deteriorated in workability and tearing resistance.

The rubber composition for a pneumatic tire tread for heavy load according to the present invention contains, together with the carbon black, 30 to 90 parts by mass of a natural rubber or a polyisoprene rubber, 10 to 70 parts by mass of a polystyrene/butadiene rubber, and 0 to 60 parts by mass of a polybutadiene rubber in 100 parts by mass of the rubber component. This combination, which is composed of the specified rubber component with the specified carbon black, produces the following advantageous effects:

(i) The composition is improved in heat-generation-restraining property to give a tire having an improved endurance.

(ii) The hardness of a tread of the tire is made high so that the tire can be prevented from being unevenly or partially abraded. Furthermore, the following inconveniences caused by the uneven or partial abrasion can also be prevented: the tire is required to be early taken off; noises are generated; and a vehicle having the tire comes to ride bad.

(iii) The rise in the hardness of the tire tread makes it possible to make grooves to be made in the tread deep.

In the rubber composition, it is preferred that the external specific surface area (STSA) of the carbon black is from 75 to 170 m²/g. The area STSA is an index of the specific surface area (particle diameter) of particles of the carbon black. If the area STSA is less than 75, the composition tends to be deteriorated in abrasion resistance. If the area is more than 170, the composition tends to be deteriorated in heat-generation-restraining property.

In the rubber composition, it is preferred that the blend amount of a reinforcing filler comprising the carbon black is from 40 to 65 parts by mass for 100 parts by mass of the rubber component, and further the carbon black content by percentage in the reinforcing filler is 80% or more by mass. If the blend amount of the reinforcing filler containing the carbon black is less than 40 parts by mass, the filler is insufficient in reinforcing performance so that the composition tends to be deteriorated in abrasion resistance. If the amount is more than 65 parts by mass, the composition tends to be deteriorated in workability and heat-generation-restraining property.

In the rubber composition, it is preferred that the polystyrene/butadiene rubber is a rubber wherein the styrene content by percentage is from 10 to 40% by mass, the content by percentage of vinyl bonds in the butadiene moieties thereof is from 10 to 40% by mass, and the content by percentage of cis bodies of the butadiene molecules in the moieties is 10% or more by mass. The combination of this polystyrene/butadiene rubber with the carbon black makes a further improvement of the composition in heat-generation-restraining property. Additionally, this combination makes it possible to increase the hardness of the tread rubber (concerned) to prevent an uneven or partial abrasion thereof with a higher certainty, and further make grooves to be made in the tread deeper.

The rubber composition contains, as a constituent of the rubber component, the polybutadiene rubber in an amount of 0 to 60 parts by mass in 100 parts by mass of the rubber component. The mass-average molecular weight of the polybutadiene rubber is preferably from 350,000 to 1,000,000. When the composition contains the polybutadiene rubber having a mass-average molecular weight of 350,000 to 1,000,000, the composition can be improved in abrasion resistance, workability, tearing resistance and heat-generation-restraining property with a good balance.

The present invention relates to a pneumatic tire 1 for heavy load, including a tread rubber region wherein the above-mentioned rubber composition, which is according to the present invention, is used. As described above, the rubber composition according to the present invention is improved in heat-generation-restraining property while kept about abrasion resistance, workability and tearing resistance. Accordingly, the pneumatic tire produced by use of this rubber composition is excellent in abrasion resistance, tearing resistance, and further heat-generation-restraining property; thus, the tire can be decreased in rolling resistance.

### BRIEF DESCRIPTION OF THE DRAWINGS

FIG. 1 is a tire-meridian sectional view illustrating an example of the pneumatic tire for heavy load according to the present invention; and

FIG. 2 is a graph obtained by plotting, about each of carbon blacks, the ratio of BET5/IA along its transverse axis and the difference “BET5−STSA” along the vertical axis.

### DETAILED DESCRIPTION OF THE PREFERRED EMBODIMENTS

The rubber composition for a pneumatic tire tread for heavy load according to the present invention includes a rubber component, and a carbon black as essential components. In the present invention, the rubber composition contains, as the rubber component, 30 to 90 parts by mass of a natural rubber or a polyisoprene rubber, 10 to 70 parts by mass of a polystyrene/butadiene rubber, and 0 to 60 parts by mass of a polybutadiene rubber in 100 parts by mass of the rubber component. In order to improve the composition in abrasion resistance, workability, tearing resistance and heat-generation-restraining property with a good balance, it is preferred that the composition contains, as the rubber component, 40 to 80 parts by mass of the natural rubber or polyisoprene rubber, 20 to 60 parts by mass of the polystyrene/butadiene rubber, and 10 to 40 parts by mass of the polybutadiene rubber in 100 parts by mass of the rubber component. The natural rubber (NR), the polyisoprene rubber (IR), the polystyrene/butadiene rubber (SBR), and the polybutadiene (BR) may each be a product obtained by denaturing a terminal end of the rubber (for example, terminal-end-denatured BR), or a product modified to give a desired characteristic to the rubber (for example, modified NR). The polybutadiene rubber (BR) may be a product synthesized by use of a cobalt (Co) catalyst, a neodymium (Nd) catalyst, a nickel (Ni) catalyst, a titanium (Ti) catalyst, or a lithium (Li) catalyst, or a product synthesized by use of a polymerizing catalyst composition containing a metallocene complex described in WO2007-129670.

The polystyrene/butadiene rubber is preferably a rubber wherein the styrene content by percentage is from 10 to 40% by mass, the content by percentage of vinyl bonds in the butadiene moieties thereof is from 10 to 40% by mass, and the content by percentage of cis bodies of the butadiene molecules in the moieties is 10% or more by mass, in particular, a rubber wherein the styrene content by percentage is from 10 to 25% by mass, the content by percentage of vinyl bonds in the butadiene moieties thereof is from 10 to 30% by mass, and the content by percentage of cis bodies of the butadiene molecules in the moieties is 25% or more by mass, considering the heat-generation-restraining property of a vulcanized rubber made from the composition. When the rubber composition according to the present invention is used for a tread rubber region of a pneumatic tire for heavy load, the polystyrene/butadiene rubber is more preferably of an oil-non-added type than of an oil-added type rubber.

In order to improve the composition in abrasion resistance, workability, tearing resistance and heat-generation-restraining property with a good balance, it is preferred to incorporate, into the rubber composition, a polybutadiene rubber having a mass-average molecular weight of 350,000 to 1,000,000, and it is particularly preferred to incorporate thereinto a polybutadiene rubber having a mass-average molecular weight of 350,000 to 1,000,000 and having a cis-1,4-butadiene-body content by percentage of 95% or more.

The rubber composition according to the present invention may contain, as a constituent of the rubber component, a diene rubber other than the natural rubber (NR), the polyisoprene rubber (IR), the polystyrene/butadiene rubber (SBR), and the polybutadiene (BR) as far as the advantageous effects of the present invention are not damaged. Examples of the diene rubber include chloroprene rubbers (CR), and nitrile rubbers (NBR). These may be used alone or in the form of a blend of two or more thereof. The rubbers may each be a product obtained by denaturing a terminal end of the rubber, or a product modified to give a desired characteristic to the rubber. When the rubbers to be used are synthetic rubbers, the polymerization method therefor, and the molecular weight and other properties thereof are not particularly limited; thus, it is allowable to select the combination of the kinds of the rubbers with the blend ratio therebetween appropriately.

In the present invention, it is the utmost characteristic that that the used carbon black satisfying the following items (1) to (4):

(1) the carbon black has a dibutyl phthalate (DBP) absorption number of 90 to 180 mL/100 g,

(2) the difference between the BET specific surface area (BET5) [unit: m²/g] of the carbon black and the external specific surface area (STSA) [unit: m²/g] thereof satisfies the following: 5<BET5−STSA<12,

(3) the ratio between the Stokes diameter (Dst) of the carbon black and the Stokes diameter distribution (ΔD-50 (half band width)) thereof satisfies the following: 0.70<(ΔD-50)/Dst<1.10, and

(4) the ratio between the BET specific surface area (BET5) [unit: m²/g] of the carbon black and the iodine adsorption number (IA) [unit: mg/g] thereof satisfies the following: 1.05<BET5/IA<1.35.

The carbon black satisfying the items (1) to (4) is a carbon black which gives carbon black aggregates wherein the number of pores made in their surfaces is smaller than the corresponding number of carbon blacks of the ISAF class (ASTM grade), and which is especial about the particle diameter, the structure and the aggregate distribution thereof. In the present invention, a tire tread can be improved in heat-generation-restraining property while kept about abrasion resistance, workability and tearing resistance by using, as a raw material of the tread, the rubber composition for a pneumatic tire tread for heavy load that contains this carbon black. More specifically, the rubber composition can realize an abrasion resistance and a tearing resistance equivalent to those of any rubber composition containing a carbon black of the ISAF class, and also realize a heat-generation-restraining property equivalent to that of any rubber composition containing a carbon black of the HAF class.

The rubber composition according to the present invention preferably contains the carbon black that is a carbon black having an external specific surface area (STSA) of 75 to 170 m²/g. In this case, the composition can attain the compatibility of abrasion resistance with heat-generation-restraining property with a better balance.

Particularly, it is preferred in the present invention that the carbon black has a dibutyl phthalate (DBP) absorption number of 90 to 180 mL/100 g, the difference between the BET specific surface area (BET5) [unit: m²/g] of the carbon black and the external specific surface area (STSA) [unit: m²/g] thereof satisfies the following: 5<BET5−STSA<10, the ratio between the Stokes diameter (Dst) of the carbon black and the Stokes diameter distribution (ΔD-50 (half band width)) thereof satisfies the following: 0.75<(ΔD-50)/Dst<0.95, and/or the ratio between the BET specific surface area (BET5) [unit: m²/g] of the carbon black and the iodine adsorption number (IA) [unit: mg/g] thereof satisfies the following: 1.10<BET5/IA<1.30. Additionally, it is preferred in the present invention that the external specific surface area (STSA) of the carbon black is from 90 to 120 m²/g.

Of the above-mentioned items for evaluating carbon black properties, the dibutyl phthalate (DBP) absorption number [unit: mL/100 g] is measured according to JIS K6217-4; the BET surface specific area (BET5) [unit: m²/g] and the external surface specific area (STSA) [unit: m²/g], according to JIS K6217-7; the Stokes diameter (Dst) and the Stokes diameter distribution (ΔD-50 (the half band width)), according to JIS K6217-6; and the iodine adsorption number (IA) [unit: mg/g], according to JIS K6217-1.

In the rubber composition according to the present invention, it is preferred that the blend amount of a reinforcing filler including the carbon black is from 40 to 65 parts by mass for 100 parts by mass of the rubber component, and further the carbon black content by percentage in the reinforcing filler is 80% or more by mass. If the blend amount of the reinforcing filler including the carbon black is less than 40 parts by mass, the filler is insufficient in reinforcing performance so that the composition tends to be deteriorated in abrasion resistance. If the amount is more than 65 parts by mass, the composition tends to be deteriorated in workability and heat-generation-restraining property. In order to improve the composition in abrasion resistance, workability, tearing resistance and heat-generation-restraining property with an even better balance, the carbon black content by percentage in the reinforcing filler is preferably 90% or more parts by mass.

Besides the carbon black, silica and a silane coupling agent may be incorporated, as fillers, into the rubber composition according to the present invention. The incorporation of, in particular, silica having a BET specific surface area (BET5) of 90 to 220 m²/g, and a dibutyl phthalate (DBP) absorption number of 120 to 220 mL/100 g can favorably give a tire tread improved in tearing resistance and abrasion resistance. However, in order to exhibit the properties of the carbon black sufficiently, the silica content by percentage in the reinforcing filler is preferably 20% or less parts by mass, more preferably 10% or less parts by mass.

Besides the rubber component, the carbon black, silica and the silane coupling agent, compounding agents usable ordinarily in the rubber industry may be appropriately incorporated into the rubber composition as far as the advantageous effects of the present invention are not damaged. Examples of the agents include sulfur, zinc oxide, stearic acid, a vulcanization accelerator, a vulcanization acceleration aid, a vulcanization retarder, an anti-ageing agent, a vulcanization reversion restrainer, softening agents such as wax and oil, and a working aid.

The sulfur may be a sulfur species ordinary for rubber, and may be, for example, powdery sulfur, precipitated sulfur, insoluble sulfur, or high-dispersible sulfur. Considering rubber physical properties, the endurance and others of the rubber composition after the composition is vulcanized, the blend amount of the sulfur is preferably from 0.5 to 5.0 parts by mass for 100 parts by mass of the rubber component.

The vulcanization accelerator may be a vulcanization accelerator usable ordinarily for rubber vulcanization. Examples thereof include sulfenamide type, thiuram type, thiazole type, thiourea type, guanidine type, dithiocarbamic acid salt type vulcanization accelerators. These may be used alone or in the form of an appropriate mixture. Considering rubber physical properties, the endurance and others of the rubber composition after the composition is vulcanized, the blend amount of the vulcanization accelerator(s) is preferably from 0.1 to 5.0 parts by mass for 100 parts by mass of the rubber component.

The anti-ageing agent may be an anti-ageing agent usable ordinarily for rubber. Examples thereof include aromatic amine type, amine-ketone type, monophenol type, bisphenol type, polyphenol type, dithiocarbamic acid salt type, and thiourea type anti-ageing agents. These may be used alone or in the form of an appropriate mixture. Considering rubber physical properties, the endurance and others of the rubber composition, the blend amount of the anti-ageing agent (s) is preferably from 0.0 to 5.0 parts by mass for 100 parts by mass of the rubber component.

The rubber composition according to the present invention is yielded by mixing and kneading the rubber component, the carbon black, silica, the silane coupling agent, and the optional compounding agent(s) usable ordinarily in the rubber industry (such as sulfur, zinc oxide, stearic acid, a vulcanization accelerator, a vulcanization acceleration acid, a vulcanization retarder, an anti-ageing agent, a vulcanization reversion restrainer, softening agents such as wax and oil, and a working aid) by use of a mixing machine usable ordinarily in the rubber industry, such as a Banbury mixing machine, a kneader or a roller.

The method for blending the individual components with each other is not particularly limited, and may be any one of a method of mixing, in advance, the blending components other than the sulfur, the vulcanization accelerator, and the other vulcanization-associated components with each other to prepare a master batch, adding the rest of all the components thereto, and further mixing the components with each other, a method of using only the rubber component and the carbon black to prepare a mixed master batch, adding the rest of all the components thereto, and then mixing the components with each other, a method of adding the individual components in any order to a mixing machine while the added components are mixed with each other, and a method of adding all the components simultaneously to a mixing machine, and then mixing the components. When the rubber component and the carbon black are used to prepare a master batch in advance, it is allowable to use a wet master batch obtained by incorporating the carbon black to a latex of the rubber component.

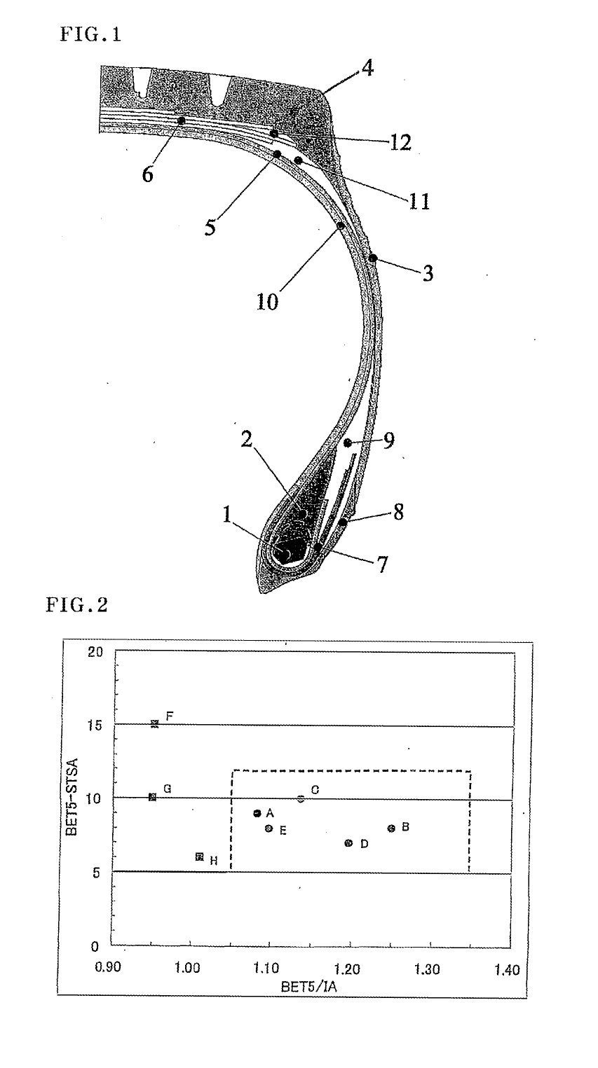

The rubber composition according to the present invention is useful as a raw material of a pneumatic tire for heavy load. As illustrated in FIG. 1, an example of the pneumatic tire for heavy load according to the present invention has a pair of bead wires 1, a bead filler 2 (having a monolayered or bilayered structure) arranged at the external side in the tire radial direction of each of the bead wires 1, side walls 3 each extended from one of the bead wires 1 and the bead filler 2 adjacent thereto toward the outside in the tire radial direction, a tread 4 continuous to an outside end in the tire radial direction of each of the side walls 3, a carcass ply 5 having ends wound from the internal side in the width direction of the tire to the external side thereof around the paired bead wires 1, respectively, and a belt 6 composed of belt plies arranged on the outer circumferential side (i.e., the external side in the tire radial direction) of the carcass ply 5. The tread 4 may be made of a single rubber region, or may be composed of two layers of a cap tread at the ground-contacting side of the tire, and a base tread at the internal side in the radial direction of the tire.

At the internal side in the tire radial direction of the bead wire 1 and the bead filler 2, a tieher 7 and a rim strip 8 are arranged to interpose the carcass ply 5 therebetween. The rim strip 8 is fitted to a tire rim (not illustrated) to contact the rim. At the external side in the tire radial direction of the bead filler 2, a tieher pad 9 is arranged to sandwich the tieher 7 between its portions. At the inner circumferential side of the carcass ply 5, an inner liner 10 for holding the pressure of the air is arranged. At an end side of the belt 6 and the internal side in the tire radial direction thereof, a shoulder pad 11 is arranged. Between ends of the belt plies, a belt edge filler 12 is arranged.

The rubber composition according to the present invention is used to produce the tread 4 by means of a known machine such as an extruder for rubber. An unvulcanized tire having this tread is formed by molding, and then vulcanized by a known method to produce a pneumatic tire for heavy load having the tread 4 having an excellent abrasion resistance, tearing resistance and heat-generation-restraining property, and a decreased rolling resistance.

### EXAMPLES

Hereinafter, a description will be made about working examples illustrating the structure and advantageous effects of the present invention specifically, and others. In evaluating items in the working examples and the others, a rubber sample obtained by heating each rubber composition at 150° C. for 30 minutes, and then vulcanizing the composition was evaluated by the following methods (under the following conditions):

(1) Workability

According to JIS K6300, the workability of the sample is evaluated on the basis of the Mooney viscosity (ML₍₁₊₄₎) obtained by making a measurement at a measuring temperature of 100° C. to set the pre-heating period and the operating period of a rotor to 1 minute and 4 minutes, respectively. The result is represented by an index number obtained by regarding the viscosity ML₍₁₊₄₎ of Comparative Example 1 as 100. As the index number is smaller, the workability is better.

(2) Tearing Resistance

According to JIS K6252, the tearing resistance is evaluated. The result is represented by an index number obtained by regarding the measured value of Comparative Example 1 as 100. As the index number is larger, the tearing resistance is better.

(3) Abrasion Resistance

According to JIS K6264, the abrasion resistance of the sample is evaluated on the basis of a result obtained by making a measurement at a slip ratio of 30%, a load of 40 N and a dropped sand amount of 20 g/minute. The result is represented by an index number obtained by regarding the measured value of Comparative Example 1 as 100. As the index number is larger, the abrasion resistance is better.

(4) Heat-Generation-Restraining Property (tan δ)

A viscoelasticity spectrometer manufactured by UBM Co. is used to evaluate the property of the sample on the basis of the loss tangent (tan δ) value measured at an initial strain of 15%, a dynamic strain of ±2.5%, a frequency of 10 Hz, and a temperature of 60° C. As the measured number is larger, the hysteresis property is better.

(5) Rubber Hardness

According to JIS K6253, the rubber hardness of the sample is measured (with an A-type durometer) at 23° C. The result is represented by an index number obtained by regarding the measured value of Comparative Example 1 as 100. As the index number is larger, the rubber hardness is higher to be better.

Preparation of Rubber Compositions for Pneumatic Tire for Heavy Load:

In accordance with respective blending-formulations shown in columns of Tables 1 and 2, components for pneumatic tire for heavy load were formulated, and then an ordinary Banbury mixer was used to knead the respective formulated compositions to prepare rubber compositions for pneumatic tire for heavy load of Examples 1 to 12, and Comparative Examples 1 to 7. Each of the blended components shown in Tables 1 and 3 is shown below (In Tables 1 and 2, the blend amount of each of carbon blacks and the other blended agents is represented by the number of “part (s) by mass” relative to 100 parts by mass of the rubber component concerned). The carbon blacks were produced by a production process described below.

a) Rubber Components:

Natural rubber (NR): “RSS#3”

Polystyrene/butadiene rubber (SBR-(1)): “JSR1502” (manufactured by JSR Corp.; styrene content by percentage: 23.5% by mass, vinyl bond content by percentage in butadiene moieties: 18% by mass, and cis-body molecule content by percentage therein: 13% by mass)

Polystyrene/butadiene rubber (SBR-(2)): “Tufdene 1000” (manufactured by Asahi Chemical Co., Ltd.; styrene content by percentage: 18% by mass, vinyl bond content by percentage in butadiene moieties: 13% by mass, and cis-body molecule content by percentage therein: 35% by mass)

Polystyrene/butadiene rubber (SBR-(3)): “JSR0202” (manufactured by JSR Corp.; styrene content by percentage: 46% by mass, vinyl bond content by percentage in butadiene moieties: 18% by mass, and cis-body molecule content by percentage therein: 13% by mass)

Butadiene rubber (BR): “BR150L” (terminal-non-modified rubber synthesized by use of a Co based catalyst, and manufactured by Ube Industries, Ltd.; Mw: 520,000)

b) Silica: “NIPSIL AQ” (manufactured by Tosoh Silica Corp.; BET specific surface area: 205 m²/g, and DBP absorption number: 150 mL/100 g)

c) Zinc flower: “AENKA No. 1” (manufactured by Mitsui Mining & Smelting Co., Ltd.)

d) Stearic acid: “BEADS STEARIC ACID” (manufactured by NOF Corp.)

e) Anti-ageing agent: “ANTIGEN 6C” (manufactured by Sumitomo Chemical Co., Ltd.)

f) Vulcanization promoter: “SOCSEAL (transliterated) CZ” (manufactured by Sumitomo Chemical Co., Ltd.)

g) Powdery sulfur (manufactured by Tsurumi Chemical Industry Co., Ltd.)

Process for Producing Carbon Blacks:

Prepared was an oil furnace composed of a burning room having, at its furnace head region, an tangential-line-direction air-supplying opening and a burning burner fitted in the axial direction of the furnace, and a small-diameter reaction room and a large-diameter reaction room which are in a multi-stage form and each have a crude oil spraying nozzle set to be connected coaxially to the burning room. The furnace was used to produce the carbon blacks (A) to (E) shown in Table 1 as follows: The carbon black mixed gas temperature was adjusted into the range of 1000 to 2200° C.; the ratio between the air amount (Nm³/h) and the raw material introduction amount (kg/h), into that of 2.0 to 6.0; the ratio between the air amount and the fuel introduction amount (kg/h), into that of 15.0 to 30.0; and the ratio between the raw material introduction amount and the fuel introduction amount, into that of 3.0 to 8.0. In order to yield, as the carbon blacks (A) to (E), carbon blacks each having a specific surface area, a structure, a surface activity, an aggregate distribution and a pore degree each specified, one from or a combination of two or more from the following i) to iv) was adopted:

i) a divisional introduction of the raw material oil,

ii) the addition of oxygen gas,

iii) the setting of the reaction time into the range of 0.002 to 0.05 second, and

iv) the setting of the drying temperature into the range of 180 to 250° C. In Table 3 are shown carbon black properties of the carbon blacks (A) to (E). Moreover, in FIG. 2 is shown a graph in which about the carbon blacks (A) to (E) the ratio of BET5/IA was plotted along the transverse axis, the difference of “BET5−STSA” was plotted along the vertical axis.

As other carbon blacks (F) to (H), commercially available carbon black products described below were used. In Table 3 are also shown carbon black properties of the carbon blacks (F) to (H). Moreover, in the graph shown FIG. 2 are also shown results obtained by plotting, about the carbon blacks (F) to (H), the ratio of BET5/IA along the transverse axis, and plotting the difference of “BET5−STSA” along the vertical axis.

g) carbon black (F): “SEAST 9 (SAF)” (manufactured by Tokai Carbon Co., Ltd.),

h) carbon black (G): “SEAST 6 (ISAF)”, (manufactured by Tokai Carbon Co., Ltd.), and

i) carbon black (H): “SEAST KH (HAF)”, (manufactured by Tokai Carbon Co., Ltd.).

TABLE 1

| | Exam- | Exam- | Exam- | Exam- | Exam- | Exam- | Exam- | Exam- | Exam- | Exam- | Exam- | Exam- |
|---|---|---|---|---|---|---|---|---|---|---|---|---|
| | ple 1 | ple 2 | ple 3 | ple 4 | ple 5 | ple 6 | ple 7 | ple 8 | ple 9 | ple 10 | ple 11 | ple 12 |
| NR | 80 | 80 | 80 | 80 | 80 | 80 | 80 | 80 | 60 | 60 | 40 | 70 |
| SBR(1) | 20 | 20 | 20 | — | — | — | — | 20 | 20 | — | — | 15 |
| SBR(2) | — | — | — | 20 | 20 | 20 | 20 | — | 20 | 40 | 30 | — |
| SBR(3) | — | — | — | — | — | — | — | — | — | — | — | — |
| BR | — | — | — | — | — | — | — | — | — | — | 30 | 15 |
| Carbon black (A) | 40 | 50 | 60 | — | — | — | — | 50 | 50 | 50 | 50 | 50 |
| Carbon black (B) | — | — | — | 50 | — | — | — | — | — | — | — | — |
| Carbon black (C) | — | — | — | — | 50 | — | — | — | — | — | — | — |
| Carbon black (D) | — | — | — | — | — | 50 | — | — | — | — | — | — |
| Carbon black (E) | — | — | — | — | — | — | 50 | — | — | — | — | — |
| Carbon black (F) | — | — | — | — | — | — | — | — | — | — | — | — |
| Carbon black (G) | — | — | — | — | — | — | — | — | — | — | — | — |
| Carbon black (H) | — | — | — | — | — | — | — | — | — | — | — | — |
| Silica | — | — | — | — | — | — | — | 5 | — | — | — | — |
| Zinc oxide | 3 | 3 | 3 | 3 | 3 | 3 | 3 | 3 | 3 | 3 | 3 | 3 |
| Stearic acid | 1 | 1 | 1 | 1 | 1 | 1 | 1 | 1 | 1 | 1 | 1 | 1 |
| Anti-ageing | 1 | 1 | 1 | 1 | 1 | 1 | 1 | 1 | 1 | 1 | 1 | 1 |
| agent | | | | | | | | | | | | |
| Vulcanization | 1 | 1 | 1 | 1 | 1 | 1 | 1 | 1 | 1 | 1 | 1 | 1 |
| promoter | | | | | | | | | | | | |
| Powdery sulfur | 2 | 2 | 2 | 2 | 2 | 2 | 2 | 2 | 2 | 2 | 2 | 2 |
| Workability | 87 | 99 | 113 | 106 | 105 | 106 | 107 | 107 | 101 | 103 | 98 | 100 |
| Rubber hardness | 94 | 103 | 114 | 103 | 104 | 103 | 103 | 105 | 104 | 104 | 104 | 103 |
| Tearing | 91 | 98 | 106 | 101 | 100 | 99 | 99 | 102 | 100 | 103 | 103 | 100 |
| resistance | | | | | | | | | | | | |
| Abrasion | 92 | 98 | 105 | 101 | 100 | 101 | 100 | 102 | 100 | 102 | 106 | 103 |
| resistance | | | | | | | | | | | | |
| Heat-generation- | 0.105 | 0.117 | 0.128 | 0.110 | 0.111 | 0.112 | 0.113 | 0.122 | 0.120 | 0.125 | 0.123 | 0.107 |
| restraining | | | | | | | | | | | | |
| property (tan δ) | | | | | | | | | | | | |

TABLE 2

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| NR | 80 | 80 | 80 | 80 | 80 | 80 | 80 |
| SBR(1) | 20 | 20 | 20 | 20 | 20 | 20 | — |
| SBR(2) | — | — | — | — | — | — | — |
| SBR(3) | — | — | — | — | — | — | 20 |
| BR | — | — | — | — | — | — | — |
| Carbon black (A) | — | — | — | — | 30 | 50 | 50 |
| Carbon black (B) | — | — | — | — | — | — | — |
| Carbon black (C) | — | — | — | — | — | — | — |
| Carbon black (D) | — | — | — | — | — | — | — |
| Carbon black (E) | — | — | — | — | — | — | — |
| Carbon black (F) | — | — | 50 | — | — | — | — |
| Carbon black (G) | 50 | 60 | — | — | — | — | — |
| Carbon black (H) | — | — | — | 50 | — | — | — |
| Silica | — | — | — | — | — | 15 | — |
| Zinc oxide | 3 | 3 | 3 | 3 | 3 | 3 | 3 |
| Stearic acid | 1 | 1 | 1 | 1 | 1 | 1 | 1 |
| Anti-ageing | 1 | 1 | 1 | 1 | 1 | 1 | 1 |
| agent | | | | | | | |
| Vulcanization | 1 | 1 | 1 | 1 | 1 | 1 | 1 |
| promoter | | | | | | | |
| Powdery sulfur | 2 | 2 | 2 | 2 | 2 | 2 | 2 |
| Workability | 100 | 113 | 110 | 99 | 76 | 125 | 100 |
| Rubber hardness | 100 | 110 | 101 | 103 | 81 | 111 | 103 |
| Tearing | 100 | 111 | 106 | 76 | 78 | 111 | 95 |
| resistance | | | | | | | |
| Abrasion | 100 | 107 | 111 | 97 | 81 | 109 | 96 |
| resistance | | | | | | | |
| Heat-generation- | 0.130 | 0.143 | 0.148 | 0.115 | 0.093 | 0.135 | 0.133 |
| restraining | | | | | | | |
| property (tan δ) | | | | | | | |

TABLE 3

| | | | DBF | | | |
|---|---|---|---|---|---|---|
| | BET5 | STSA | mL/ | (BET5) − | (BET5)/ | (ΔD-50)/ |
| | (m²/g) | (m²/g) | 100 g | (STSA) | (IA) | (Dst) |
| Carbon | 105 | 96 | 133 | 9 | 1.082 | 0.777 |
| black (A) | | | | | | |
| Carbon | 115 | 107 | 136 | 8 | 1.250 | 0.831 |
| black (B) | | | | | | |
| Carbon | 108 | 98 | 134 | 10 | 1.137 | 1.040 |
| black (C) | | | | | | |
| Carbon | 109 | 102 | 119 | 7 | 1.198 | 0.805 |
| black (D) | | | | | | |
| Carbon | 112 | 104 | 131 | 8 | 1.098 | 0.793 |
| black (E) | | | | | | |
| Carbon | 135 | 120 | 116 | 15 | 0.951 | 0.671 |
| black (F) | | | | | | |
| Carbon | 115 | 105 | 116 | 10 | 0.950 | 0.833 |
| black (G) | | | | | | |
| Carbon | 89 | 83 | 117 | 6 | 1.011 | 0.857 |
| black (H) | | | | | | |

From the results in Table 1, it is understood that the vulcanized rubbers made from the rubber compositions for pneumatic tire for heavy load according to Examples 1 to 12, which each contain any one of the carbon blacks (A) to (E), are each very good in heat-generation-restraining property as well as abrasion resistance, workability and tearing resistance since the used carbon black satisfies all of the above-mentioned requirements (1) to (4). By contrast, it is understood from the results in Table 2 that the vulcanized rubbers made from the rubber compositions for pneumatic tire for heavy load according to Comparative Examples 1 to 7, which each contain any one of the carbon blacks (F) to (H), are each poor in one or more of abrasion resistance, workability and tearing resistance and heat-generation-restraining property since the used carbon black does not satisfy one or more of the above-mentioned requirements (1) to (4).

What is claimed is:

1. A rubber composition for a pneumatic tire tread for heavy load, comprising a rubber component, and a carbon black,
wherein the rubber component contains 30 to 90 parts by mass of a natural rubber or a polyisoprene rubber, 10 to 70 parts by mass of a polystyrene/butadiene rubber, and 0 to 60 parts by mass of a polybutadiene rubber in 100 parts by mass of the rubber component, and
the carbon black satisfies the following (1) to (4):
(1) the carbon black has a dibutyl phthalate (DBP) absorption number of 90 to 180 mL/100 g,
(2) the difference between the BET specific surface area (BET5) [unit: m²/g] of the carbon black and the external specific surface area (STSA) [unit: m²/g] thereof satisfies the following: 5<BET5−STSA<12,
(3) the ratio between the Stokes diameter (Dst) of the carbon black and the Stokes diameter distribution (ΔD-50 (half band width)) thereof satisfies the following: 0.70<(ΔD-50)/Dst<1.10, and
(4) the ratio between the BET specific surface area (BET5) [unit: m²/g] of the carbon black and the iodine adsorption number (IA) [unit: mg/g] thereof satisfies the following: 1.05<BET5/IA<1.35.

2. The rubber composition according to claim 1, wherein the external specific surface area (STSA) of the carbon black is from 75 to 170 m²/g.

3. The rubber composition according to claim 1, wherein the blend amount of a reinforcing filler comprising the carbon black is from 40 to 65 parts by mass for 100 parts by mass of the rubber component, and further the carbon black content by percentage in the reinforcing filler is 80% or more by mass.

4. The rubber composition according to claim 2, wherein the blend amount of a reinforcing filler comprising the carbon black is from 40 to 65 parts by mass for 100 parts by mass of the rubber component, and further the carbon black content by percentage in the reinforcing filler is 80% or more by mass.

5. A pneumatic tire for heavy load, comprising a tread rubber region in which a rubber composition as recited in claim 1 is used.

6. A pneumatic tire for heavy load, comprising a tread rubber region in which a rubber composition as recited in claim 2 is used.

7. A pneumatic tire for heavy load, comprising a tread rubber region in which a rubber composition as recited in claim 3 is used.

8. A pneumatic tire for heavy load, comprising a tread rubber region in which a rubber composition as recited in claim 4 is used.
